(19) United States
(12) Patent Application Publication
(10) Pub. No.: US 2016/0344072 A1
(43) Pub. Date: Nov. 24, 2016

(54) RECHARGEABLE BATTERY MODULE

(71) Applicant: Go-Tech Energy Co., Ltd., New Taipei City (TW)

(72) Inventors: Wan-Sheng CHAN, Keelung (TW); Hsun-Hao CHIEH, New Taipei City (TW)

(73) Assignee: GO-TECH ENERGY CO., LTD., New Taipei City (TW)

(21) Appl. No.: 14/715,988

(22) Filed: May 19, 2015

(51) Int. Cl. H01M 10/6551

(52) U.S. Cl. CPC H01M 10/6551; H01M 2220/20; H01M 2220/30

(57) ABSTRACT

A rechargeable battery module is disclosed in the present invention. The rechargeable battery module includes a number of rechargeable battery cells, each having identical appearance, arranged in the same direction and fixed to on another by at least one fixing element, wherein the rechargeable battery cells are linked in series and/or in parallel to store and provide power; at least one anode end conductive sheet, electrically connected to anodes of at least two rechargeable battery cells; at least one cathode end conductive sheet, electrically connected to cathodes of at least two rechargeable battery cells; and a number of silicone thermal conducting structures.

### FIELD OF THE INVENTION

The present invention relates to a rechargeable battery module. More particularly, the present invention relates to a rechargeable battery module having fixing structures and heat dissipating function.

### BACKGROUND OF THE INVENTION

Rechargeable batteries are widely used in many products, such as notebooks, tablets, mobile phones, and even large electric vehicles and robots. Since space in the aforementioned devices is limited. How to arrange the rechargeable battery set (battery cells) and prevent them from coming off due to vibration to ensure heat dissipating can be effectively operated is a problem for engineers to take care of for individual case any time.

Review the prior arts, there are many techniques can be applied. Please refer to FIG. 1. The U.S. Pat. No. 6,465,123 discloses a box type rechargeable battery module 1. It is composed of a bottom plate 11 and several fixing structure 12. The fixing structure 12 includes a number of semi-circular structures formed to one another. The semi-circular structure can just accommodate a half of rechargeable battery cell 20. There are corresponding semi-circular structures on the bottom plate 11. The semi-circular structure of the fixing structure 12 can combine that of the bottom plate 11 to fix several rechargeable battery cells 20. In addition, two semi-circular structures of the fixing structure 12 can also combine to fix other rechargeable battery cells 20. Thus, multi-layer rechargeable battery cell 20 are composed to be a main part of the battery module 1. Finally, a cover (not shown) will be fixed with the bottom plate 11. The battery module 1 is formed. Many battery modules are manufactured by similar means as disclosed in the present invention. However, an obvious defect is that such structure needs different toolings according to different applied subjects (devices). As far as the cost is concerned, it is not economic. Meanwhile, cooling effect is limited.

As shown in FIG. 2, a battery module 3 is also provided in another prior art. It includes: a first battery bracket 31, a second battery bracket 32 and a liquid cooling module 33. Each battery bracket 31 and 32 has a number of hollowed accommodating portions 34 to accommodate a number of battery units 40, correspondingly. The liquid cooling module 33 includes: an entrance channel 331, an outlet channel 332, a channel board 333 having a channel and a first connecting member 334 and a second connecting member 335 linked to opposite sides of the channel board 333. The first battery bracket 31 and the second battery bracket 32 can be stacked to each other. The channel board 333 is installed between the first battery bracket 31 and the second battery bracket 32 with two opposite sides fixed by the first connecting member 334 and second connecting member 335, respectively. After a cooling liquid comes from the entrance channel 331, it flows to the channel of the channel board 333. The heat generated by the battery unit 40 in the battery brackets 31 and 32 can be taken away and conducted to the second connecting member 335 on the other side. Then, the cooling liquid flows out from the outlet channel 332.

The aforementioned battery module 3 definitely can conduct the heat generated by the battery unit 40 in operation out of the battery module 3 fast and efficiently due to the design of the liquid cooling module 33. But since it needs an extra structure, the liquid cooling module 33, cost of constructing the battery module 3 is high. It is time consumptive to assemble.

Therefore, a rechargeable battery module having low cost, being easily assembled, operating with efficient heat dissipation and able to fix the internal battery cells, is still desired.

### SUMMARY OF THE INVENTION

The known rechargeable battery modules have problems of heat dissipation and higher cost. In addition, in order to fix the rechargeable battery cells inside and enhance heat dissipation, assembly of the rechargeable battery module becomes very inconvenient. The effect of the heat dissipation is not good, either.

Hence, rechargeable battery modules having low cost, being easily assembled, operating with efficient heat dissipation and able to fix the internal battery cells is desired. The rechargeable battery module according to the present invention fulfills the features mentioned above.

According to an aspect of the present invention, a rechargeable battery module includes: a number of rechargeable battery cells, each having identical appearance, arranged in the same direction and fixed to on another by at least one fixing element, wherein the rechargeable battery cells are linked in series and/or in parallel to store and provide power; at least one anode end conductive sheet, electrically connected to anodes of at least two rechargeable battery cells; at least one cathode end conductive sheet, electrically connected to cathodes of at least two rechargeable battery cells; and a number of silicone thermal conducting structures, each silicone thermal conducting structure installed above the anode end conductive sheet or below the cathode end conductive sheet, touching the anode of the rechargeable battery cell with the anode end conductive sheet or touching the cathode of the rechargeable battery cell with the cathode end conductive sheet, for conducting the heat of the anode or the cathode to outside of the rechargeable battery cells.

The rechargeable battery module may further includes at least one external thermal conducting structure, contacted with the silicone thermal conducting structure, for conducting heat of the silicone thermal conducting structure to the external environment.

Preferably, the fixing element is glue, fixed and filled among the rechargeable battery cells.

The fixing element may further includes: two end fixing structures, each having: an end accommodating portion, having at least one limiting structure, used to accommodate one end of the rechargeable battery cell and limit movement of the rechargeable battery cell not to go beyond the limiting structure; and a number of end portion fixing tube, connected to the end accommodating portion; a number of bolts; and a number of nuts. The two end fixing structures are positioned in opposite directions. Each bolt passes through one end portion fixing tube to a corresponding end portion fixing tube in the other end fixing structure. The rechargeable battery cells between the two end fixing structures are fixed along an axial direction of the bolt by connecting with a nut. An end of the end accommodating portion has an opening to expose an electrode.

Preferably, the end fixing structure is made by thermosetting plastic or metal material.

Preferably, a material of the anode end conductive sheet is graphite, nickel, aluminum, brass or copper.

Preferably, a material of the cathode end conductive sheet is graphite, nickel, aluminum, brass or copper.

Preferably, the silicone thermal conducting structure is in a shape of a strip, a ladder or a coarse grid.

The rechargeable battery module provided by the present invention can efficiently dissipate heat during operation and fix the rechargeable battery cells inside, in case the rechargeable battery cells come off due to vibration. It is simple in using materials. Price is also cheap comparing with conventional rechargeable battery modules. Meanwhile, the rechargeable battery module is easily assembled. It is convenient to conduct the heat from the rechargeable battery cells to the external environment with the silicone thermal conducting structures and the external thermal conducting structures.

### BRIEF DESCRIPTION OF THE DRAWINGS

FIG. 1 is a perspective view of a prior art of a box type rechargeable battery module.

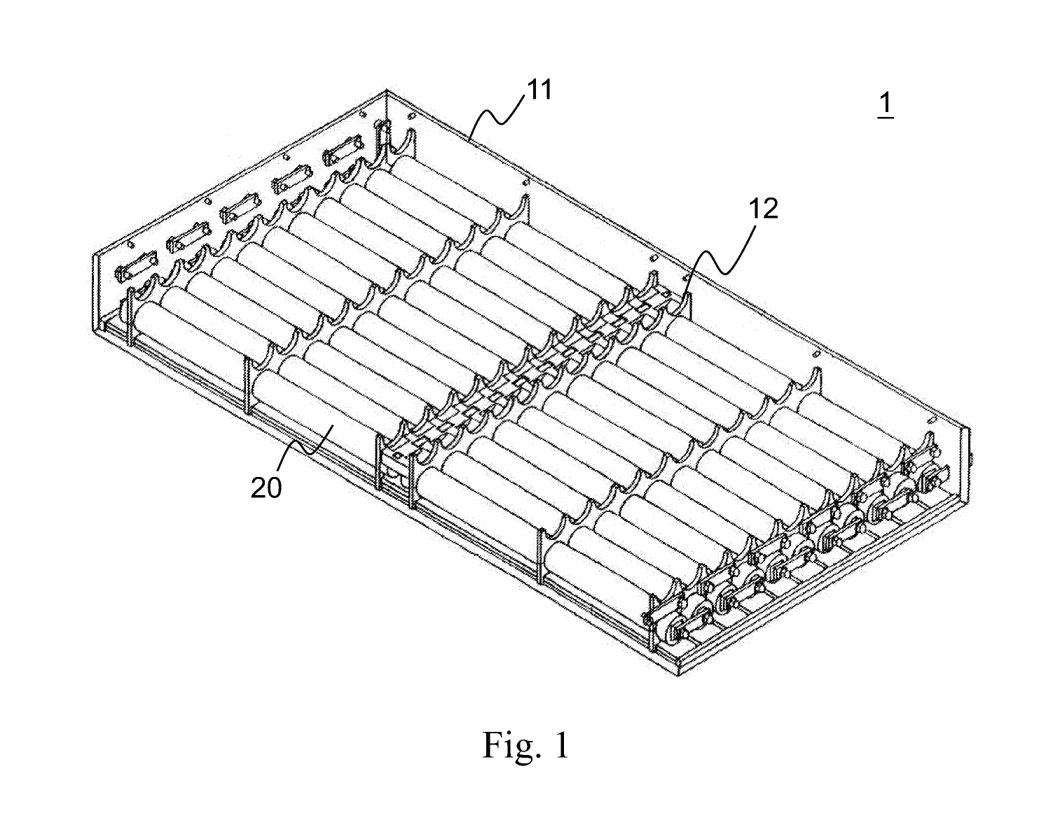

FIG. 2 is an exploded view of a prior art of a battery module.

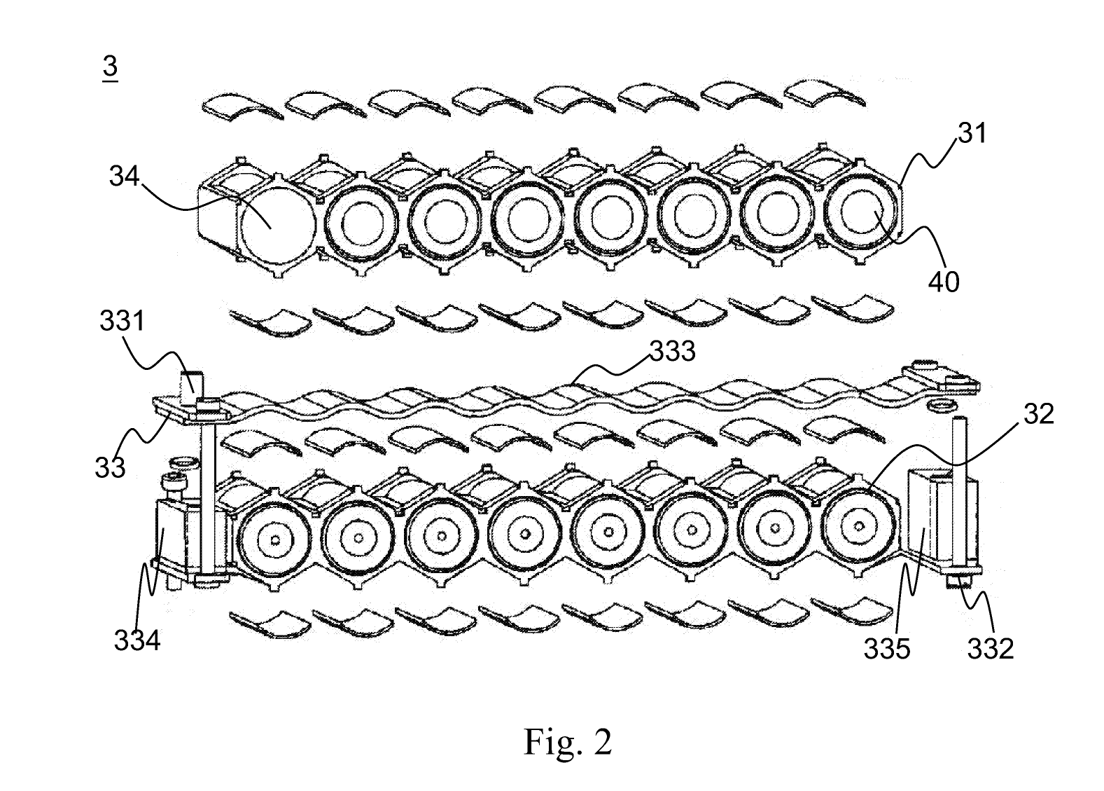

FIG. 3 is an exploded view of an embodiment of a rechargeable battery module according to the present invention.

FIG. 4 is a cross-sectional view of the rechargeable battery module.

FIG. 5 shows a partial assembly of the rechargeable battery module.

FIG. 6 is an exploded view of another embodiment of a rechargeable battery module according to the present invention.

### DETAILED DESCRIPTION OF THE PREFERRED EMBODIMENTS

The present invention will now be described more specifically with reference to the following embodiments.

### First Embodiment

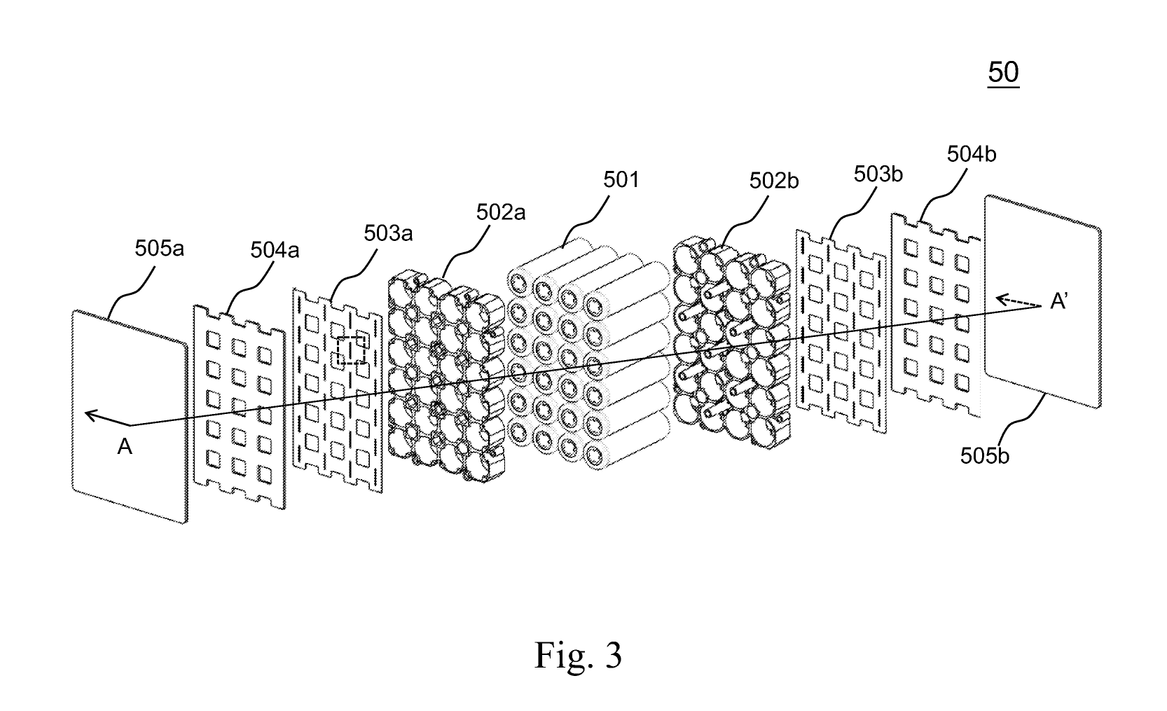

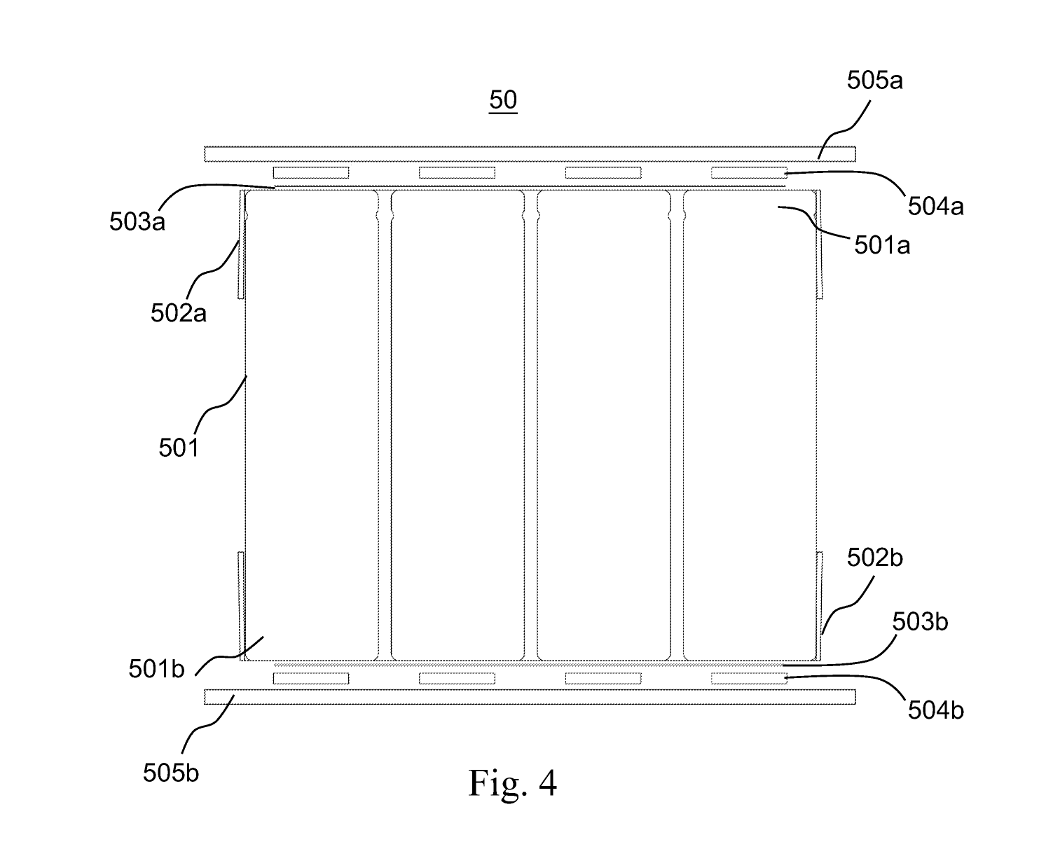

Please refer to FIG. 3 to FIG. 5 FIG. 3 is an exploded view of a rechargeable battery module. FIG. 4 is a cross-sectional view of a rechargeable battery module being assembled. A plane of the cross-section is along an AA′ line of the rechargeable battery module in FIG. 3, horizontally crossing form one side of the rechargeable battery module to the other side. It is available from FIG. 3, a rechargeable battery module 50 according to the present invention includes: 24 rechargeable battery cells 501, a anode end fixing structure 502a, a cathode end fixing structure 502b, a anode end conductive sheet 503a, a cathode end conductive sheet 503b, a anode silicone thermal conducting structure 504a, a cathode silicone thermal conducting structure 504b, a anode external thermal conducting structure 505a and a cathode external thermal conducting structure 505b. It should be noticed that the present embodiment is designed according to a requirement of a specified power source. In practice, the rechargeable battery module 50 can have at least two rechargeable battery cells 501. The number is not limited to 24.

For the 24 rechargeable battery cells 501, each one has identical appearance, arranged in the same direction fixed to on another by at least one fixing element. An 18650 type lithium rechargeable battery is commonly used. Those rechargeable battery cells are linked in series and/or in parallel. They are the core of the rechargeable battery module 50 and can store and provide power. As shown in FIG. 4, the rechargeable battery cells 501 are arranged in 4 rows with 6 units in a row. The arrangement is not limited to this. It can vary with the number of rechargeable battery cells. For example, if the number of the rechargeable battery cells 501 is 16, the arrangement may be 4 rows with 4 units in a row, or 2 rows with 8 units in a row. In design, it is better to arrange the rechargeable battery cells 501 in the same plane in case of waste of space. The rechargeable battery cell 501 may be connected to each other in series or parallel to provide a specified amount of power. Since the present invention does not relate to connecting methods of rechargeable battery cells. Any design of connecting method of the rechargeable battery cells 501 fulfilling the power requirement of a unit rechargeable battery pack is applicable. In the present embodiment, 24 rechargeable battery cells 501 are connected in parallel by linking all anodes to the anode end conductive sheet 503a and all cathodes to the cathode end conductive sheet 503b.

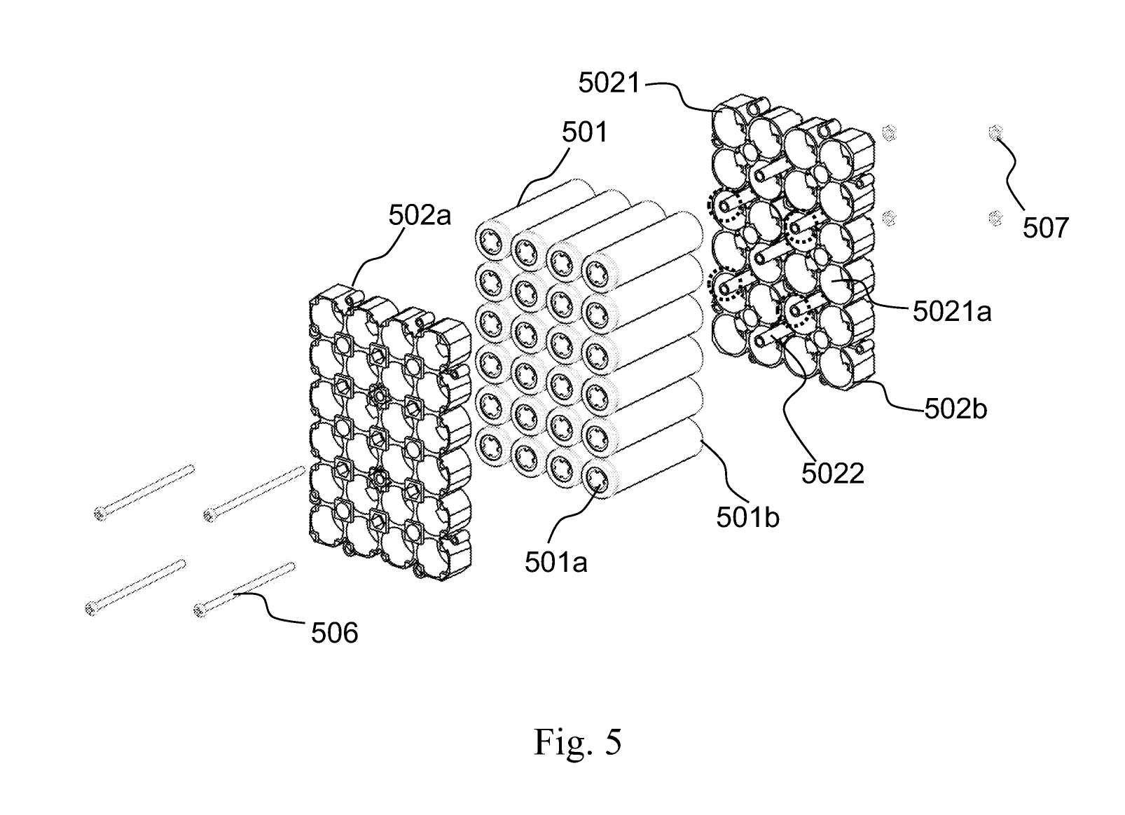

As a simple fixing way, said fixing element may be glue. It is fixed and filled among the rechargeable battery cells 501. However, the fixing ability of the glue will get deteriorated after having being used for a period of time. It causes the rechargeable battery cells 501 scattered. A good type of the fixing element is provided by the present invention. Please see FIG. 5. The fixing element includes the said two end fixing structures (the anode end fixing structure 502a and the cathode end fixing structure 502b), several bolts 506 and several nuts 507. The anode end fixing structure 502a and the cathode end fixing structure 502b are identical in the appearance. Each of them has 1 end accommodating portion 5021 and 7 end portion fixing tubes 5022. The end accommodating portion 5021 is composed of at least one limiting structure 5021a. The end accommodating portion 5021 is used to accommodate one end of the rechargeable battery cells 501 (namely, the limiting structures 5021a of the anode end fixing structure 502a are used to accommodate anode ends 501a of the rechargeable battery cell 501. The limiting structures 5021a of the cathode end fixing structure 502b are used to accommodate cathode ends 501b of the rechargeable battery cells 501) and to limit movement of the rechargeable battery cells 501 not to go beyond the limiting structures 5021a. In the present embodiment, since there are 24 rechargeable battery cells 501, the number of the limiting structures 5021a is also 24. The number of the limiting structures 5021a can be increased or decreased with that of the rechargeable battery cells 501. More is acceptable.

One and of the end portion fixing tube 5022 is connected to the end accommodating portion while the other end is extruded out of the end accommodating portion 5021. Two ends are not sealed. Distribution of the end portion fixing tubes 5022 for the anode end fixing structure 502a or the cathode end fixing structure 502b should be point symmetric. Thus, two identical fixing structures can be positioned in opposite directions and fixed by one end of the end portion fixing tubes 5022. In the present embodiment, distribution of the end portion fixing tube 5022 is point symmetric about the center of the end accommodating portion 5021. One of the end portion fixing tubes 5022 can let a bolt 506 pass through to a corresponding end portion fixing tube 5022 of the other end fixing structure. The two end portion fixing tubes 5022 are connected by connecting the bolt 506 with a nut 507. Therefore, along an axial direction of the bolt 506, the 24 rechargeable battery cells 501 can be fixed between the anode end fixing structure 502a and the cathode end fixing structure 502b. It should be noticed that an end of the end accommodating portion 5022 has an opening to expose an electrode. In the present embodiment, although there are 7 end portion fixing tubes 5022, not all of them have to be fixed by bolts 506. As shown in FIG. 5, there are only 4 sets of bolts 506 and nuts 507 are used for fixing the end portion fixing tube 5022 marked by dashed circles.

As to material, the anode end fixing structure 502a and the cathode end fixing structure 502b can be made by a thermosetting plastic or metal material. For the thermosetting plastic, Acrylonitrile Butadiene Styrene (ABS) is better; for the metal material, aluminum or aluminum alloy is preferred.

In the present embodiment, the number of the anode end conductive sheet 503a and that of the cathode end conductive sheet 503b are both one. In practice, it is not limited (multi-conductive sheets structure is illustrated in a second embodiment). The anode end conductive sheet 503a is used to electrically connecting to at least two anodes of the rechargeable battery cells 501. The cathode end conductive sheet 503b is used to electrically connect to at least two cathodes of the rechargeable battery cells 501. The anode end 501a and the cathode end 501b exposed at the end of the end accommodating portion 5022 are directly contacted to a “1” type slim slot in the anode end conductive sheet 503a and the cathode end conductive sheet 503b, respectively (one of them is remarked by a square dashed frame in FIG. 3). The slim slots and the pierced portions on each conductive sheet are a design used to reduce thermal expansion deformation. In practice, they may not be necessary. Material of said two conductive sheets should be brass since it is cheap in price, better in elasticity and high in conductivity coefficient. In practice, they can use graphite, nickel, aluminum or copper as the material.

The anode silicone thermal conducting structure 504a is installed on the anode end conductive sheet 503a, touching the anode of the rechargeable battery cell 501 with the anode end conductive sheet 503a, for conducting the heat of the anode to outside of the rechargeable battery cells 501. Similarly, the cathode silicone thermal conducting structure 504b is installed below the cathode end conductive sheet 503b, touching the cathode of the rechargeable battery cell 501 with the cathode end conductive sheet 503b, for conducting the heat of the cathode to outside of the rechargeable battery cells 501. In the present embodiment, the anode silicone thermal conducting structure 504a and the cathode silicone thermal conducting structure 504b are both in a shape of a coarse grid. The intersections of longitudinal belts and transverse belts are where the electrodes touch with the conductive sheet. The anode silicone thermal conducting structure 504a and the cathode silicone thermal conducting structure 504b may be formed by stamping silicone sheets. The coarse grid can not only save materials, but also accommodate the portions of the bolts 506 and the nuts 507 in the fixing element protruding the conductive sheet. For some battery module which is installed in a system with ventilation, the heat from the lateral side of the rechargeable battery cells can be taken away by the circulating air through the pierced portions.

In the present embodiment, the anode external thermal conducting structure 505a and the cathode external thermal conducting structure 505b are two pieces of metal sheets, installed on the external side of the rechargeable battery module 50. The two external thermal conducting structures contact the two silicone thermal conducting structures, respectively for conducting heat of the silicone thermal conducting structure to the external environment. However, in order to conveniently assemble the rechargeable battery module 50, the anode external thermal conducting structure 505a and the cathode external thermal conducting structure 505b may also be a portion of a housing of the rechargeable battery module 50, just different in locations.

### Second Embodiment

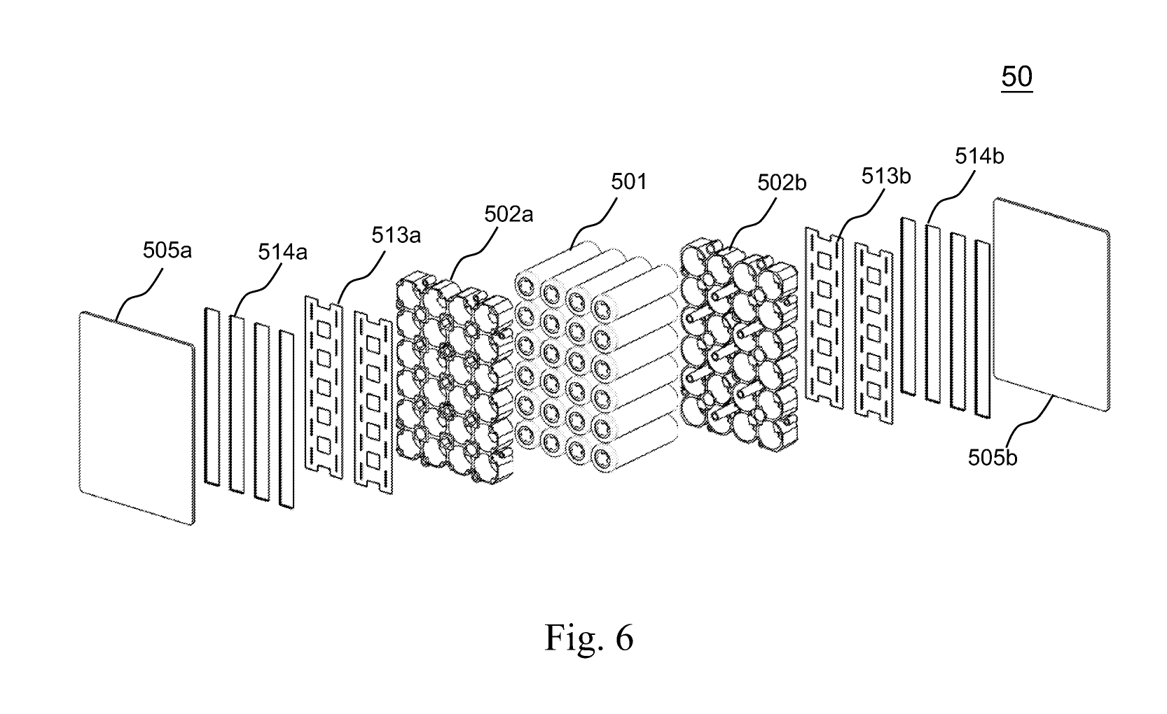

According to the spirit of the present invention, the composition of the rechargeable battery module 50 can be changed by the following. Please refer to FIG. 6. FIG. 6 is an exploded view of a second embodiment. Elements having the same numeral in both FIG. 6 and FIG. 3 have the same functions and location. It is clear from FIG. 6, the original anode end conductive sheet 503a, cathode end conductive sheet 503b, anode silicone thermal conducting structure 504a and cathode silicone thermal conducting structure 504b, are replaced by 2 anode end conductive sheets 513a, 2 cathode end conductive sheets 513b, 4 anode silicone thermal conducting structures 514a and 4 cathode silicone thermal conducting structures 514b. The following illustration describes new functions of the replacing elements.

In this embodiment, material of the anode end conductive sheet 513a and the cathode end conductive sheet 513b is the same as that of the anode end conductive sheet 503a. For appearance, the two conductive sheets are in the form of a ladder. The 12 rechargeable battery cells 501 on the left side are connected in parallel by one set of anode end conductive sheet 513a and cathode end conductive sheet 513b. The rest 12 rechargeable battery cells 501 on the right side are connected in parallel by the other set of anode end conductive sheet 513a and cathode end conductive sheet 513b. The two sets of rechargeable battery cells 501 can be further connected in series. Namely, only using the same rechargeable battery cells 501 and fixing element in the first embodiment, different spec of voltage can be outputted. In addition, the anode silicone thermal conducting structure 514a and the cathode silicone thermal conducting structure 514b are in the form of strips. Of course, they can be formed as ladders as the anode end conductive sheet 513a. Strip shape has advantages of easy formation. It is just not easy to position the silicone thermal conducting structure onto the anode end conductive sheet 513a or the cathode end conductive sheet 513b.

While the invention has been described in terms of what is presently considered to be the most practical and preferred embodiment, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A rechargeable battery module, comprising:
a plurality of rechargeable battery cells, each having identical appearance, arranged in the same direction and fixed to on another by at least one fixing element, wherein the rechargeable battery cells are linked in series and/or in parallel to store and provide power;
at least one anode end conductive sheet, electrically connected to anodes of at least two rechargeable battery cells;
at least one cathode end conductive sheet, electrically connected to cathodes of at least two rechargeable battery cells; and
a plurality of silicone thermal conducting structures, each silicone thermal conducting structure installed above the anode end conductive sheet or below the cathode end conductive sheet, touching the anode of the rechargeable battery cell with the anode end conductive sheet or touching the cathode of the rechargeable battery cell with the cathode end conductive sheet, for conducting the heat of the anode or the cathode to outside of the rechargeable battery cells.

2. The rechargeable battery module according to claim 1, further comprising at least one external thermal conducting structure, contacted with the silicone thermal conducting structure, for conducting heat of the silicone thermal conducting structure to the external environment.

3. The rechargeable battery module according to claim 1, wherein the fixing element is glue, fixed and filled among the rechargeable battery cells.

4. The rechargeable battery module according to claim 1, wherein the fixing element further comprising:
two end fixing structures, each having:
an end accommodating portion, having at least one limiting structure, used to accommodate one end of the rechargeable battery cell and limit movement of the rechargeable battery cell not to go beyond the limiting structure; and
a plurality of end portion fixing tube, connected to the end accommodating portion;
a plurality of bolts; and
a plurality of nuts;
wherein, the two end fixing structures are positioned in opposite directions;
each bolt passes through one end portion fixing tube to a corresponding end portion fixing tube in the other end fixing structure; the rechargeable battery cells between the two end fixing structures are fixed along an axial direction of the bolt by connecting with a nut; an end of the end accommodating portion has an opening to expose an electrode.

5. The rechargeable battery module according to claim 4, wherein the end fixing structure is made by thermosetting plastic or metal material.

6. The rechargeable battery module according to claim 1, wherein a material of the anode end conductive sheet is graphite, nickel, aluminum, brass or copper.

7. The rechargeable battery module according to claim 1, wherein a material of the cathode end conductive sheet is graphite, nickel, aluminum, brass or copper.

8. The rechargeable battery module according to claim 1, wherein the silicone thermal conducting structure is in a shape of a strip, a ladder or a coarse grid.
